(19) United States
(12) Patent Application Publication
(10) Pub. No.: US 2026/0046640 A1
(43) Pub. Date: Feb. 12, 2026

(54) SOUNDING METHOD, APPARATUS AND NON-TRANSITORY COMPUTER-READABLE MEDIA FOR COORDINATED BEAMFORMING IN A WIRELESS NETWORK

(71) Applicant: MEDIATEK INC., Hsinchu City (TW)

(72) Inventors: Ray-Kuo LIN, Hsinchu City (TW); Huai-Yan FENG, Hsinchu City (TW); Tsungjung LEE, Hsinchu City (TW)

(21) Appl. No.: 19/295,866

(22) Filed: Aug. 11, 2025

Related U.S. Application Data
(60) Provisional application No. 63/681,955, filed on Aug. 12, 2024.

(51) Int. Cl. H04W 16/28; H04W 24/10; H04W 88/08

(52) U.S. Cl. CPC H04W 16/28; H04W 24/10; H04W 88/08

(57) ABSTRACT

A sounding method for coordinated beamforming in a multi-AP wireless network is provided. The method is implemented by a first wireless access point (AP) of a first basic service set (BSS), and includes transmitting a sounding packet to a second wireless station (STA) of a second BSS, wherein the sounding packet comprises a field indicating that a transmitter address is an address of a second wireless AP associated with a second BSS. The method includes receiving a feedback report from the second wireless STA of the second BSS, wherein the feedback report comprises interference channel of the second wireless STA.

### CROSS REFERENCE TO RELATED APPLICATIONS

This application claims the benefit of U.S. Provisional Application No. 63/681,955, entitled “Sounding method of coordinated beamform”, filed on Aug. 12, 2024, the entirety of which is incorporated by reference herein.

### BACKGROUND OF THE INVENTION

### Field of the Invention

The present disclosure generally relates to the field of wireless communications technology. More specifically, aspects of the present disclosure relate to a sounding method, apparatus and non-transitory computer readable medium for coordinated beamforming in a wireless communication network.

### Description of the Related Art

Modern electronic devices typically send and receive data wirelessly with other electronic devices, e.g., using Wi-Fi within a wireless local area network (WLAN), and the performance of WLAN can be improved by using more than one wireless access point device (wireless AP). By using multiple APs in a multi-AP wireless network, the overall efficiency and performance of the WLAN can be greatly improved, and poor network connections resulting from obstructions and interference can be avoided. Moreover, a wireless AP in a multi-AP wireless network can fail without disrupting the entire wireless network since another wireless AP can take over.

In a multi-AP (MAP) wireless network, multiple wireless APs enrolled in the multi-AP wireless network and multiple wireless stations (STAs) can cause interference during cooperative Multi-AP transmission. To prevent or mitigate this unwanted interference, the output of the physical antennas of wireless APs can be modified using beamforming so that different channels used by the collaborative APs and the associated STAs do not cause interference. Beamforming techniques are commonly applied to cancel interfering signals and produce a strong beam to communicate a data signal, for example, using computed weighted vectors. One goal of collaborative beamforming is to allow APs of the multi-AP wireless network to transmit concurrently without causing interference with each other. Therefore, to perform collaborative beamforming efficiently, devices of the multi-AP wireless network should perform collaborative beamforming based on up-to-date channel state information, such as measured interference levels of different channels so that interference between devices can be prevented or substantially reduced.

Channel sounding is a technique that evaluates radio environments for wireless communication, for example, in MIMO or multi-AP wireless networks. As wireless signals propagate in multiple paths (the multipath effect) due to physical obstacles, channel sounding techniques are used to process and observe the multidimensional spatial-temporal signal and estimate channel characteristics.

However, there is currently no specification for how to perform a channel sounding between an AP associated with a basic service set (BSS) of the AP and STAs of BSSs which are not the BSS of the AP.

Therefore, there is a need for a sounding method, apparatus and non-transitory computer readable medium for coordinated beamforming in a wireless communication network to solve these problems.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a sounding method, apparatus and non-transitory computer readable medium for coordinated beamforming in a wireless communication network to illustrate how to perform the channel sounding between an AP associated with a BSS of the AP and STAs of BSSs which is not the BSS of the AP.

In an exemplary embodiment, a sounding method for coordinated beamforming in a multi-AP wireless network is provided. The method is implemented by a first wireless access point (AP) associated with a first basic service set (BSS) and comprises transmitting a sounding packet to a second wireless station (STA) of a second BSS, wherein the sounding packet comprises a field indicating that a transmitter address is an address of a second wireless AP associated with a second BSS. The method comprises receiving a feedback report from the second wireless STA of the second BSS, wherein the feedback report comprises interference channel of the second wireless STA.

According to some embodiments, the method further comprises configuring the first wireless AP for performing a coordinated beamforming to mitigate interference with the second wireless STA of the second BSS according to the feedback report.

According to some embodiments, the sounding packet is a media access control (MAC) frame.

According to some embodiments, the sounding packet is one of a null data packet announcement (NDPA) frame and a beamforming report poll (BFRP) frame.

According to some embodiments, the first BSS is different from the second BSS.

In an exemplary embodiment, an apparatus for coordinated beamforming in a multi-AP wireless network is provided. The apparatus comprises circuitry. The circuitry is configured to transmit a sounding packet to a second wireless station (STA) of a second basic service set (BSS), wherein the sounding packet comprises a field indicating that a transmitter address is an address of a second wireless AP associated with a second BSS. The circuitry is configured to: receive a feedback report from the second wireless STA of the second BSS, wherein the feedback report comprises interference channel of the second wireless STA, wherein the apparatus is associated with a first BSS.

In an exemplary embodiment, a non-transitory computer-readable medium storing instructions that, when executed by a processor of a first wireless access point (AP) associated with a first basic service set (BSS), cause the processor to perform a sounding method for coordinated beamforming in a multi-AP wireless network. The sounding method comprises transmitting a sounding packet to a second wireless station (STA) of a second BSS, wherein the sounding packet comprises a field indicating that a transmitter address is an address of a second wireless AP associated with a second BSS. The sounding method comprises receiving a feedback report from the second wireless STA of the second BSS, wherein the feedback report comprises interference channel of the second wireless STA.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a block diagram of an exemplary Multi-AP wireless network depicted according to embodiments of the present disclosure.

FIG. 2 depicts an exemplary data transmission and timing diagram for performing a coordinated beamforming of a collaborative sounding protocol in a multi-AP wireless network according to embodiments of the present disclosure with reference to FIG. 1.

FIG. 3 is a diagram illustrating a frame control field in a media access control (MAC) frame in a multi-AP wireless network to which the present disclosure may be applied.

FIG. 4 shows a schematic structural diagram of a beamforming report poll (BFRP) frame according to an embodiment of the present disclosure.

FIG. 5 is a schematic structural diagram of beamforming report poll (BFRP) frame according to an embodiment of the present disclosure.

FIG. 6 is a flow chart of an exemplary sequence of computer implemented steps of a process for performing a sounding method for coordinated beamforming according to embodiments of the present disclosure with reference to FIGS. 1-2.

FIG. 7 shows an apparatus according to embodiments of the disclosure.

### DETAILED DESCRIPTION OF THE INVENTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

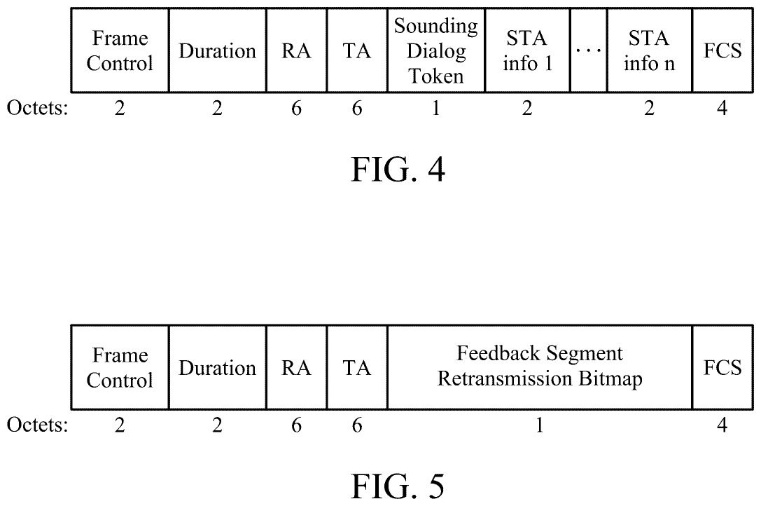

Portions of the detailed description that follow are presented and discussed in terms of a method. Although steps and sequencing thereof are disclosed in a figure herein (e.g., FIG. 4) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “configuring,” “coordinating,” “storing,” “transmitting,” “authenticating,” “identifying,” “requesting,” “reporting,” “determining,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Overview

As used herein, the term “EHT” may refer generally to a recent generation of wireless communication known as Extremely High Throughput (EHT) and is defined according to the IEEE 802.11be standards. The term station (STA) refers generally to an electronic device capable of sending and receiving data over wireless communication that is not operating as an access point (AP).

Embodiments of the present disclosure provide a sounding method, apparatus and non-transitory computer readable medium for coordinated beamforming in a wireless communication network that determines channel state information between devices (e.g., the channel state between an STA and a collaborative AP) for efficient configuration of the multi-AP wireless network and to improve the performance of the multi-AP wireless networks. For example, when an AP obtains a transmission opportunity (TXOP), the AP as a TXOP holder can share a portion (e.g., a resource unit (RU)) of the bandwidth allocated by the TXOP with one or more other collaborative APs. In one example, coordinated beamforming is used to nullify the interference between collaborative APs so that the APs can simultaneously transmit data substantially without interference.

### Illustrative Implementations

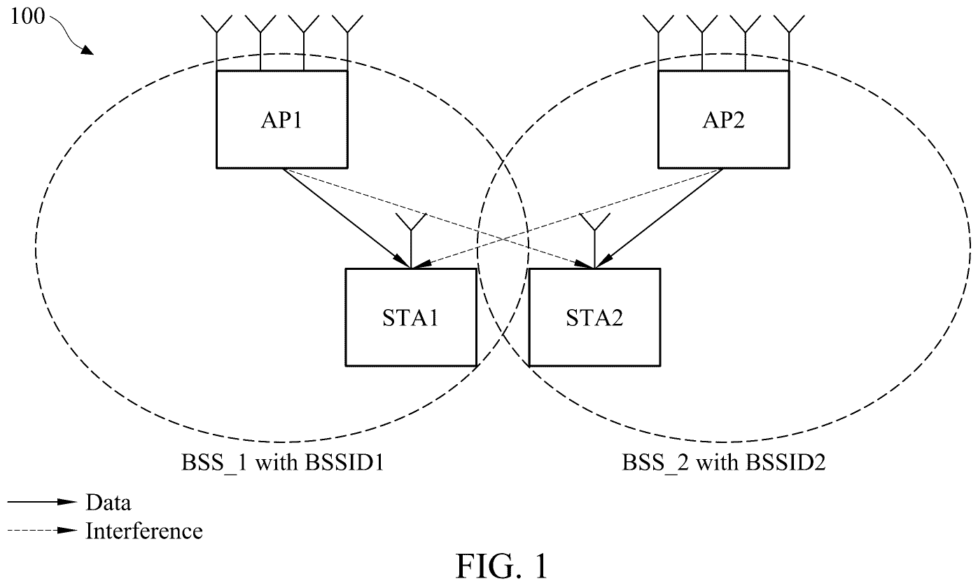

With regard to FIG. 1, an exemplary MAP wireless network 100 is depicted according to embodiments of the present disclosure. When a wireless AP obtains a TXOP frame, the wireless AP (e.g., the TXOP holder) can share a portion of the RU of the bandwidth granted by the TXOP with one or more other collaborative APs within the TXOP. Collaborative beamforming is one approach to enable sharing the RU in the spatial domain. The wireless AP and wireless STAs associated with collaborative APs can simultaneously transmit by applying coordinated beamforming where the interferences between channels nullify each other (e.g., nulling), and the beamforming is performed based on a sounding phase performed by the collaborative APs.

FIG. 1 depicts downlink (DL) transmissions between collaborative AP1 and AP2 services wireless stations STA1 and STA2. In this example, AP1, STA1 belong to a first basic service set (BSSID1), and AP2 and STA2 belong to a second basic service set (BSSID2). The first basic service set and the second basic service set can be considered one basic service set; however, the first basic service set is associated with a first BSSID and the second basic service set is associated with a second BSSID. The dashed lines represent potential interference between channels. The solid lines represent downlink data transmissions. It is appreciated that the APs and the STAs can also be configured to perform beamforming for cooperative uplink (UL) transmissions.

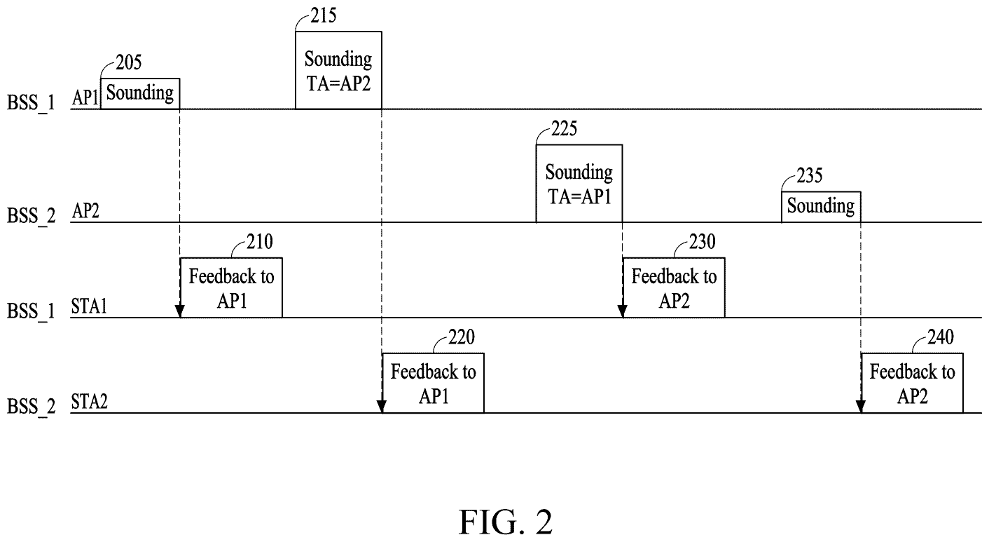

FIG. 2 depicts an exemplary data transmission and timing diagram 200 for performing a coordinated beamforming of a collaborative sounding protocol in a multi-AP wireless network according to embodiments of the present disclosure with reference to FIG. 1, wherein the wireless AP1 is associated with a first BBS (BSS_1) and the wireless AP2 is associated with a second BBS (BSS_2), and the first BBS is not different from the second BBS.

As depicted in FIG. 2, the wireless AP1 transmits a sounding packet 205 to the wireless STA1 belongs to a first BSS, wherein the sounding packet 205 comprises a field indicating that a transmitter address (TA) is the address of the wireless AP1 associated with the first BSS. The wireless AP1 receives a feedback report 210 from the wireless STA1 of the first BSS, wherein the feedback report 210 comprises channel state between the wireless STA1 and the wireless AP1.

Then, the wireless AP1 transmits a sounding packet 215 to the wireless STA2 belongs to a second BSS, wherein the sounding packet 215 comprises a field indicating that a transmitter address (TA) is the address of the wireless AP2 associated with the second BSS. In other words, the wireless AP1 pretends to be the wireless AP2 to request the wireless STA2 to reply to the channel state between the wireless STA2 and the wireless AP2.

The wireless AP1 receives a feedback report 220 from the wireless STA2 of the second BSS, wherein the feedback report 220 comprises the channel state including the interference channel of the wireless STA2.

Similarly, the wireless AP2 transmits a sounding packet 225 to the wireless STA1 belongs to the first BSS, wherein the sounding packet 225 comprises a field indicating that a transmitter address (TA) is the address of the wireless AP1 associated with the first BSS. In other words, the wireless AP2 pretends to be the wireless AP1 to request the wireless STA1 to reply to the channel state between the wireless STA1 and the wireless AP1. The wireless AP2 receives a feedback report 230 from the wireless STA1 of the first BSS, wherein the feedback report 230 comprises the channel state including the interference channel of the wireless STA1.

Then, the wireless AP2 transmits a sounding packet 235 to the wireless STA2 belongs to the second BSS, wherein the sounding packet 235 comprises a field indicating that a transmitter address (TA) is the address of the wireless AP2 associated with the second BSS. The wireless AP2 receives a feedback report 240 from the wireless STA2 of the second BSS, wherein the feedback report 240 comprises channel state between the wireless AP2 and the wireless STA2.

According to some embodiments, the interference channel represents the channel state (e.g., interference) between a STA and an AP that is not associated with the STA. In addition, the feedback report including interference channel is also known as the inter-BSS feedback report because it indicates the channel state between the AP of the BSS of which the STA is not a member and the STA.

In some implementations, the sounding packet 205, 215, 225 or 235 is a media access control (MAC) frame.

In some implementations, the sounding packet 205, 215, 225 or 235 is one of a null data packet announcement (NDPA) frame and a beamforming report poll (BFRP) frame.

It should be noted that the order in which the wireless AP1 and the wireless AP2 transmit the sounding packets does not limit what is shown in FIG. 2, and those with ordinary skill in the art can make appropriate replacements or adjustments according to this embodiment.

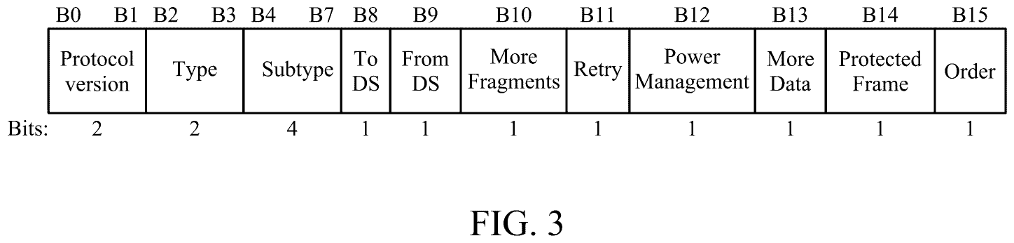

FIG. 3 is a diagram illustrating a frame control field in a media access control (MAC) frame in a multi-AP wireless network to which the present disclosure may be applied.

Referring to FIG. 3, the frame control field includes a Protocol Version subfield, a Type subfield, a Subtype subfield, a To DS subfield, a From DS subfield, a More Fragments subfield, a Retry subfield, a Power Management subfield, a More Data subfield, a Protected Frame subfield, and an Order subfield, wherein the TA field is present in some control frame subtypes.

FIG. 4 shows a schematic structural diagram of a beamforming report poll (BFRP) frame according to an embodiment of the present disclosure. As shown in FIG. 4, the NDPA frame includes a MAC header, a sounding dialog token field, one or more pieces of station information, and a frame check sequence (FCS) field.

The MAC header includes (1) a frame control field, used to indicate a type of the MAC frame; (2) a duration field, used to indicate duration of occupying a channel by the MAC frame and a corresponding acknowledgment frame; (3) a receiving address (RA) field, used to identify a receive end of the MAC frame; and (4) a transmitting address (TA) field, used to identify a transmit end of the MAC frame.

In coordinated beamforming, a first wireless AP associated with a first BBS transmits the NDPA frame to a second wireless STA associated with a second BBS, wherein the NDPA frame includes a TA field indicating that a transmitter address is an address of a second wireless AP associated with the second BSS.

FIG. 5 is a schematic structural diagram of beamforming report poll (BFRP) frame according to an embodiment of the present disclosure. As shown in FIG. 5, the BFRP frame includes a MAC header (including the frame control field, the duration field, the receiving address (RA) field and the transmitting address (TA) field), a feedback segment retransmission bitmap and an FCS field. For meanings of the foregoing fields, refer to the 802.11 standard. Details are not described herein.

Also, a first wireless AP associated with a first BBS sets the TA field of the BFRP frame to the address of a second wireless AP associated with a second BSS, and transmits the BFRP frame to a second wireless STA associated with the second BBS.

### Illustrative Processes

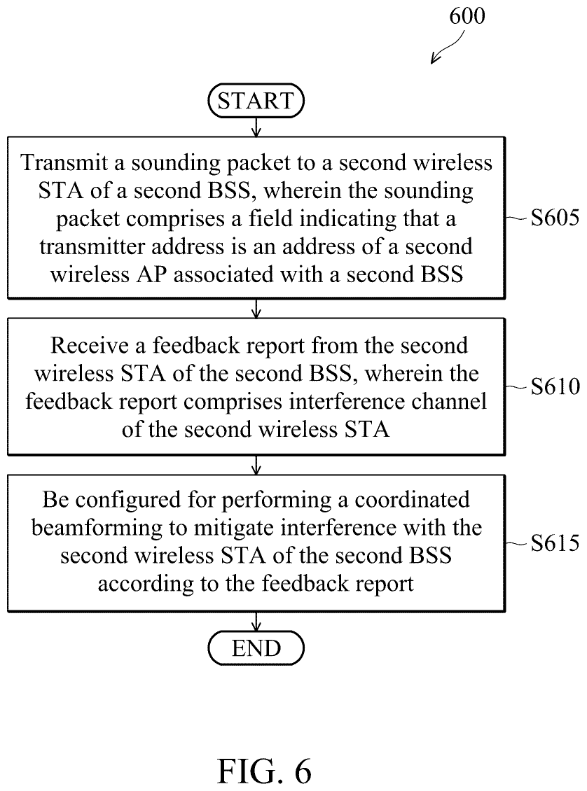

FIG. 6 is a flow chart of an exemplary sequence of computer implemented steps of a process 600 for performing a sounding method for coordinated beamforming according to embodiments of the present disclosure with reference to FIGS. 1-2. The process 600 can be implemented by a first wireless AP associated with a first BSS.

At step 605, the first wireless AP transmits a sounding packet to a second wireless STA of a second BSS, wherein the sounding packet comprises a field indicating that a transmitter address is the address of a second wireless AP associated with a second BSS.

At step 610, the first wireless AP receives a feedback report from the second wireless STA of the second BSS, wherein the feedback report comprises the interference channel of the second wireless STA.

At step 615, the first wireless AP is configured for performing a coordinated beamforming to mitigate interference with the second wireless STA of the second BSS according to the feedback report.

In some implementations, the sounding packet is a media access control (MAC) frame.

In some implementations, the sounding packet is one of a null data packet announcement (NDPA) frame and a beamforming report poll (BFRP) frame.

In some implementations, the first BSS is different from the second BSS.

### Illustrative Apparatuses

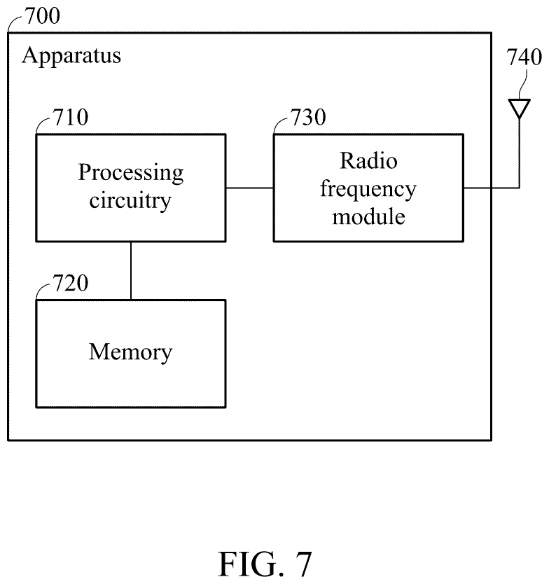

FIG. 7 shows an apparatus 700 according to embodiments of the disclosure. The apparatus 700 can be configured to perform various functions in accordance with one or more embodiments or examples described herein. Thus, the apparatus 700 can provide means for implementation of mechanisms, techniques, processes, functions, components, systems described herein. For example, the apparatus 700 can be used to implement functions of APs or STAs in various embodiments and examples described herein. The apparatus 700 can include a general purpose processor or specially designed circuits to implement various functions, components, or processes described herein in various embodiments. The apparatus 700 can include processing circuitry 710, a memory 720, and a radio frequency (RF) module 730.

In various examples, the processing circuitry 710 can include circuitry configured to perform the functions and processes described herein in combination with software or without software. In various examples, the processing circuitry 710 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 710 can be a central processing unit (CPU) configured to execute program instructions to perform various functions and processes described herein. Accordingly, the memory 720 can be configured to store program instructions. The processing circuitry 710, when executing the program instructions, can perform the functions and processes. The memory 720 can further store other programs or data, such as operating systems, application programs, and the like. The memory 720 can include non-transitory storage media, such as a read only memory (ROM), a random access memory (RAM), a flash memory, a solid state memory, a hard disk drive, an optical disk drive, and the like.

In an embodiment, the RF module 730 receives a processed data signal from the processing circuitry 710 and converts the data signal to beamforming wireless signals that are then transmitted via antenna arrays 740, or vice versa. The RF module 730 can include a digital to analog converter (DAC), an analog to digital converter (ADC), a frequency up converter, a frequency down converter, filters and amplifiers for reception and transmission operations. The RF module 730 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 740 can include one or more antenna arrays.

The apparatus 700 can optionally include other components, such as input and output devices, additional or signal processing circuitry, and the like. Accordingly, the apparatus 700 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A sounding method for coordinated beamforming in a multi-AP wireless network, wherein the method is implemented by a first wireless access point (AP) associated with a first basic service set (BSS), and comprises:
transmitting a sounding packet to a second wireless station (STA) of a second BSS, wherein the sounding packet comprises a field indicating that a transmitter address is an address of a second wireless AP associated with a second BSS; and
receiving a feedback report from the second wireless STA of the second BSS, wherein the feedback report comprises interference channel of the second wireless STA.

2. The sounding method for coordinated beamforming in a multi-AP wireless network as claimed in claim 1, further comprising:
configuring the first wireless AP for performing a coordinated beamforming to mitigate interference with the second wireless STA of the second BSS according to the feedback report.

3. The sounding method for coordinated beamforming in a multi-AP wireless network as claimed in claim 1, wherein the sounding packet is a media access control (MAC) frame.

4. The sounding method for coordinated beamforming in a multi-AP wireless network as claimed in claim 1, wherein the sounding packet is one of a null data packet announcement (NDPA) frame and a beamforming report poll (BFRP) frame.

5. The sounding method for coordinated beamforming in a multi-AP wireless network as claimed in claim 1, wherein the first BSS is different from the second BSS.

6. An apparatus for coordinated beamforming in a multi-AP wireless network, comprising circuitry configured to:
transmit a sounding packet to a second wireless station (STA) of a second basic service set (BSS), wherein the sounding packet comprises a field indicating that a transmitter address is an address of a second wireless AP associated with a second BSS; and
receive a feedback report from the second wireless STA of the second BSS, wherein the feedback report comprises interference channel of the second wireless STA;
wherein the apparatus is associated with a first BSS.

7. The apparatus for coordinated beamforming in a multi-AP wireless network as claimed in claim 6, wherein the method further comprises:
configuring the apparatus for performing a coordinated beamforming to mitigate interference with the second wireless STA of the second BSS according to the feedback report.

8. The apparatus for coordinated beamforming in a multi-AP wireless network as claimed in claim 6, wherein the sounding packet is a media access control (MAC) frame.

9. The apparatus for coordinated beamforming in a multi-AP wireless network as claimed in claim 6, wherein the sounding packet is one of a null data packet announcement (NDPA) frame and a beamforming report poll (BFRP) frame.

10. The apparatus for coordinated beamforming in a multi-AP wireless network as claimed in claim 6, wherein the first BSS is different from the second BSS.

11. A non-transitory computer-readable medium storing instructions that, when executed by a processor of a first wireless access point (AP) associated with a first basic service set (BSS), cause the processor to perform a sounding method for coordinated beamforming in a multi-AP wireless network, the sounding method comprising:
transmitting a sounding packet to a second wireless station (STA) of a second BSS, wherein the sounding packet comprises a field indicating that a transmitter address is an address of a second wireless AP associated with a second BSS; and
receiving a feedback report from the second wireless STA of the second BSS, wherein the feedback report comprises interference channel of the second wireless STA.

12. The non-transitory computer-readable medium as claimed in claim 11, further comprising:
configuring the first wireless AP for performing a coordinated beamforming to mitigate interference with the second wireless STA of the second BSS according to the feedback report.

13. The non-transitory computer-readable medium as claimed in claim 11, wherein the sounding packet is a media access control (MAC) frame.

14. The non-transitory computer-readable medium as claimed in claim 11, wherein the sounding packet is one of a null data packet announcement (NDPA) frame and a beamforming report poll (BFRP) frame.

15. The non-transitory computer-readable medium as claimed in claim 11, wherein the first BSS is different from the second BSS.
